(19) United States
(12) Patent Application Publication
(10) Pub. No.: US 2023/0266504 A1
(43) Pub. Date: Aug. 24, 2023

(54) Optical Element

(71) Applicant: Nippon Telegraph and Telephone Corporation, Tokyo (JP)

(72) Inventors: Masato Takiguchi, Musashino-shi, Tokyo (JP); Masaya Notomi, Musashino-shi, Tokyo (JP); Hideaki Taniyama, Musashino-shi, Tokyo (JP); Akihiko Shinya, Musashino-shi, Tokyo (JP)

(21) Appl. No.: 18/041,056

(22) PCT Filed: Sep. 1, 2020
(86) PCT No.: PCT/JP2020/033034

§ 371 Date: Feb. 8, 2023

(51) Int. Cl. G02B 1/00

(52) U.S. Cl. CPC G02B 1/005

(57) ABSTRACT

An optical element includes a plate-shaped photonic crystal body including a base and a plurality of lattice elements having a cylindrical hollow structure. The lattice elements are, for example, a cylinder. The plurality of lattice elements are periodically provided on a base in a lattice shape at intervals equal to or less than a wavelength of a target light. The photonic crystal body is a so-called two-dimensional slab type photonic crystal. Furthermore, the optical element includes a light confinement part composed of the lattice elements into which a microstructure made of a solid material is inserted.

### TECHNICAL FIELD

The present invention relates to an optical element composed of a photonic crystal.

### BACKGROUND ART

Optical elements using a photonic crystal are an element having a refractive index modulation structure provided periodically and having a photonic band gap (a band through which light does not pass) formed by the periodicity of the modulation structure. The refractive index modulation structure is, for example, holes, and the holes are arranged in a lattice pattern in two-dimensional directions. Light can be strongly confined in such a small region and the structure can be used as, for example, a resonator by introducing a defect into this modulation structure. This structure can be made as small as possible and can be an optical element capable of performing a high-speed operation with low energy consumption. Optical elements using this photonic crystal are attracting attention in photoelectric fusion type processors, biosensors, quantum information applications, and the like.

Two-dimensional photonic crystals among photonic crystals have made significant progress because they can be manufactured by utilizing existing semiconductor processes and various elements have been demonstrated not only in simulation but also experimentally. Particularly, the performance of nano-sized resonators using photonic crystals is improving day by day and it has been reported that a Q value exceeds 10 million.

In order to prepare a structure of light confinement due to lattice defects in photonic crystals, generally, optical simulations are used to drill holes in photonic crystals, in other words, to introduce defective structures with filled holes and to see if light is trapped there. In particular, it is possible to search for a structure in which a Q value becomes high by precisely moving positions of a plurality of holes around a defective structure. In this way, a photonic crystal in which holes do not actually exist at a designed location is prepared after the structure is determined through simulation.

For example, a resist layer formed of a photosensitive resist is formed on the surface of a plate-shaped base having a photonic crystal and an electron beam exposure apparatus is used to form a latent image of a designed pattern on the resist layer. Subsequently, the resist layer on which the latent image is formed is developed to form a resist pattern of the designed pattern (drawing process). Subsequently, the base is etched using the formed resist pattern as a mask. In this way, generally, in a photonic crystal resonator, the positions of the hole portions and the lattice defect portion are designed in advance and the hole portions and the lattice defect portion as designed are formed at the base to prepare, for example, a resonator structure.

As described above, with regard to the preparation of optical elements using photonic crystals by precisely designing the positions of holes in advance, techniques of forming a light confinement structure at a desired location after forming a basic photonic crystal structure are also being studied. A resonator in which a trench structure is prepared in an optical waveguide made of a photonic crystal and nano-wires made of a semiconductor are disposed in the prepared trench structure is provided as an example (Patent Literature 1, Non Patent Literature 1). In this technique, a mode in which light propagates is shifted at a location where the nano-wires are disposed. In other words, the position of a photonic band gap is shifted at the location where the nano-wires are disposed. If such a mode gap is formed in the optical waveguide, a resonator (mode gap resonator) is formed in this portion.

As described above, according to a technique of forming a light confinement structure at a desired location after preparing a configuration of a photonic crystal, there is an advantage or the like that a nano-sized optical resonator can be easily prepared at any place in the photonic crystal structure without the need for a precise drawing process in advance.

### CITATION LIST

### Patent Literature

[PTL 1] Japanese Patent Application Publication No. 2014-027168

### Non Patent Literature

[NPL 1] M. Takiguchi et al., “Continuous-wave operation and 10-Gb/s direct modulation of InAsP/InP sub-wavelength nano-wire laser on silicon photonic crystal”, APL Photonics 2, vol. 2, No. 4, 046106, 2017.
[NPL 2] F. S. F. Brossard et al., “Inkjet-Printed Nanocavities on a Photonic Crystal Template”, Advanced Materials, vol. 29, Issue 47, 1704425, 2017.
[NPL 3] F. Intonti et al., “Rewritable photonic circuits”, Applied Physics Letters, vol. 89, No. 21, 211117, 2006.

### SUMMARY OF INVENTION

### Technical Problem

In the above-mentioned technique in the related art, the resonator is formed by forming a mode gap in the optical waveguide made of a photonic crystal. On the other hand, in a configuration in which a light confinement structure is formed due to lattice defects, for example, a structure has been demonstrated in which a liquid is dripped using a micropipette into a hole at a desired location in a bulk two-dimensional photonic crystal and the hole is filled with the liquid to form a resonator (Non Patent Literature 2, Non Patent Literature 3).

However, since the liquid is used in this technique, there is a problem that the device cannot be maintained for a long period of time due to evaporation of the liquid. Further, for example, the liquid will evaporate if an intensity of an input light is strong and a stable operation cannot then be expected. In addition, it is difficult to introduce a light emitting material and apply the light emitting material to a laser or the like in a liquid. As described above, there is a problem that it is not easy to constitute various optical elements that operate stably in the technique in the related art by forming a photonic crystal and then forming a light confinement structure due to lattice defects in this photonic crystal.

The present invention was made to solve the above problems, and an object of the present invention is to obtain various optical elements which operate stably by forming a photonic crystal and then forming a light confinement structure due to lattice defects.

### Solution to Problem

An optical element according to the present invention includes a base and a plurality of lattice elements of a cylindrical hollow structure formed in the base, in which the plurality of lattice elements include a plate-like photonic crystal body periodically provided in a lattice shape at intervals equal to or less than a wavelength of target light and a light confinement part composed of lattice elements into which a microstructure made of a solid material is inserted.

### Advantageous Effects of Invention

As described above, according to the present invention, since the microstructure made of a solid material is inserted into the lattice element, various optical elements that operate stably can be obtained by forming a photonic crystal and then forming a light confinement structure due to lattice defects.

### BRIEF DESCRIPTION OF DRAWINGS

FIG. 1A is a plan view showing a configuration of an optical element according to an embodiment of the present invention.

FIG. 1B is a cross-sectional view showing the configuration of the optical element according to the embodiment of the present invention.

FIG. 1C is a cross-sectional view showing a partial configuration of the optical element according to the embodiment of the present invention.

FIG. 2 is a characteristic diagram showing a result of simulating a magnetic field distribution of the optical element according to the embodiment.

FIG. 3A is a cross-sectional view showing a partial configuration of another optical element according to the embodiment of the present invention.

FIG. 3B is a cross-sectional view showing a partial configuration of another optical element according to the embodiment of the present invention.

FIG. 4 is a perspective view showing a partial configuration of another optical element according to the embodiment of the present invention.

FIG. 5 is a characteristic diagram showing a result of simulating a magnetic field distribution of another optical element according to the embodiment.

FIG. 6A is a plan view showing a partial configuration of another optical element according to the embodiment of the present invention.

FIG. 6B is a plan view showing a partial configuration of another optical element according to the embodiment of the present invention.

FIG. 6C is a plan view showing a partial configuration of another optical element according to the embodiment of the present invention.

### DESCRIPTION OF EMBODIMENTS

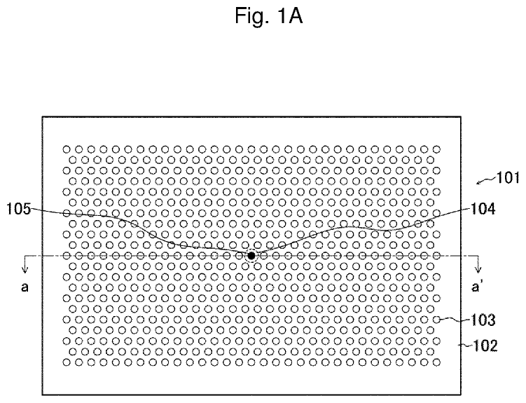

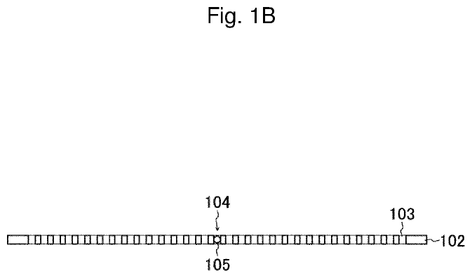

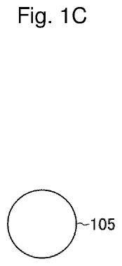

An optical element according to an embodiment of the present invention will be described below with reference to FIGS. 1A, 1B, and 1C. Note that FIG. 1B shows a cross section of line aa′ of FIG. 1A.

The optical element first includes a plate-shaped photonic crystal body 101 including a base 102 and a plurality of lattice elements 103 of a cylindrical hollow structure. The lattice element 103 is, for example, a cylinder. Furthermore, the lattice element 103 may be a prism or a triangular prism. The plurality of lattice elements 103 are periodically provided in the base 102 in a lattice shape at intervals equal to or less than the wavelength of the target light. For example, the lattice elements 103 are periodically provided in a triangular lattice shape. Furthermore, the lattice elements 103 can be periodically provided in a square lattice shape. The photonic crystal body 101 is a so-called two-dimensional slab type photonic crystal. The base 102 can be composed of, for example, SiN, Si, GaAs, InP, GaP, or the like.

Furthermore, the optical element includes a light confinement part 104 composed of a lattice element 103 into which a microstructure 105 made of a solid material is inserted. The light confinement part 104 in which the microstructure 105 is inserted into the lattice element 103 functions as a point defect on the lattice point of the photonic crystal body 101. In this example, the microstructure 105 is spherical. Furthermore, the microstructure 105 can be made of polystyrene.

For example, commercially available polystyrene nano-beads can be used as the microstructure 105. Furthermore, a nano-sized microstructure 105 can be manufactured by using a known electron beam lithography technique and etching technique.

In this case, the dimensions can be adjusted extremely precisely to obtain the desired nano-sized microstructure 105 (see References). Furthermore, particle size standard particles (nano-beads) having extremely uniform diameter dimensions and being a measurement standard are commercially available at low cost.

The nano-sized microstructure 105 described above can be easily disposed on the photonic crystal body 101 on the lattice element 103 at a desired location with well-known nano-manipulation techniques such as those using microneedles, microgrippers, atomic force microscope needles, and transfer printing.

Since the microstructure 105 is made of a solid material in the optical element according to the embodiment, it does not evaporate within a normal use range. Furthermore, the microstructure 105 has a higher refractive index than the liquid and improving the resonator characteristics is easy. Furthermore, the optical element can be applied to a light emitting element such as a laser by constructing the microstructure 105 from a direct transition type semiconductor. Furthermore, it is also possible to provide functionality (light-emitting properties) by forming a predetermined thin layer on the surface of the microstructure 105. For example, a thin, functional thin layer at an atomic layer or molecular layer level can be formed on the surface of the microstructure 105 by using a well-known atomic layer deposition (ALD) method.

Furthermore, unlike the liquid, the microstructure 105 can be precisely disposed at a desired position so that a manufacturing yield of the resonator can be increased. Attempting to drip a liquid onto a desired lattice element is not easy, and in the case of a liquid, a defective product will be obtained if the liquid is dropped on an erroneous place. On the other hand, when the microstructure 105 is used, changing the disposition position is easy.

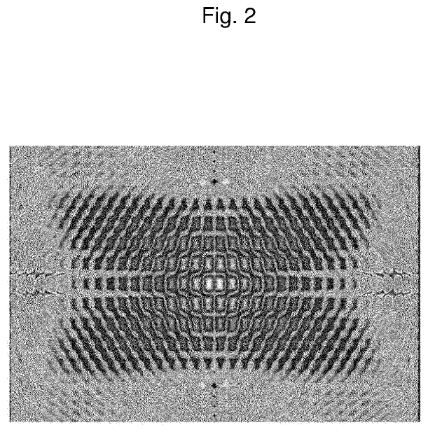

The result of simulating the magnetic field distribution of the optical element according to the embodiment will be described below with reference to FIG. 2. The conditions in the simulation that the base 102 is made of SiN (refractive index 1.99) and the microstructure 105 is made of polystyrene (refractive index 1.54). Furthermore, the lattice element 103 has a hole diameter of 364 nm and a height of the lattice element 103 (plate thickness of the base 102) is 304 nm. Furthermore, the lattice constant (distance between adjacent lattice elements 103) of the photonic crystal body 101 is set to 540 nm. In addition, as an ideal condition, the simulation is performed on the assumption that the diameter of the spherical microstructure 105 and the hole diameter of the lattice element 103 are the same.

Although the photonic crystal body 101 does not have a light confinement structure (resonator), the resonator mode is formed as shown in FIG. 2 because the microstructure 105 is inserted into the lattice element 103 at the location of the light confinement part 104. In the actual preparation of the optical element, a diameter of the microstructure 105 needs to be slightly smaller than a hole diameter of the lattice element 103. The plurality of spherical microstructures 105 are dispersed on the photonic crystal body 101, and then moved to the lattice element 103 at a predetermined position by a micro-gripper or a needle of an atomic force microscope to be inserted into the lattice element 103. Since the microstructure 105 is adsorbed on the surface inside the hole of the lattice element 103 due to an electrostatic force, the microstructure 105 does not fall (jump out) from the lattice element 103.

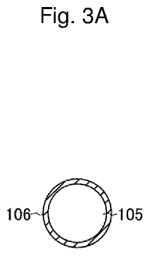

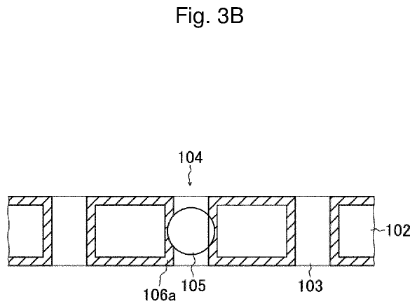

Incidentally, a spacer layer 106 made of a solid material can be formed on the surface of the microstructure 105, as shown in FIG. 3A. Furthermore, a spacer layer 106a made of a solid material can also be placed between the microstructure 105 and the side wall in the hole of the lattice element 103, as shown in FIG. 3B. In this case, the spacer layer 106a is in the state of being formed on the side wall in the hole of the lattice element 103.

The spacer layer 106 and the spacer layer 106a can be made of, for example, ZnO. For example, the spacer layer 106 and the spacer layer 106a can be formed by forming a ZnO layer using a known ALD method. Furthermore, the spacer layer 106 and the spacer layer 106a can be made of a polymer material (polymer) doped with a light emitter such as a dye or colloidal quantum dots. These can be formed using a known coating method. When the microstructure 105 is formed on the lattice element 103, a gap is substantially formed between the microstructure 105 and the lattice element 103. Particularly, when the microstructure 105 is spherical, even if the hole diameter of the lattice element 103 and the diameter of the microstructure are substantially the same, a gap is formed between the lattice element 103 and the microstructure. As described above, when the spacer layer is formed, a light emitter or an optical absorption medium can be disposed in the above-mentioned gap and it can be expected that an electric field between the spacer layer and the light confinement part 104 (resonator) interacts efficiently. As a result, when the spacer layer is provided, the optical element according to the embodiment can be applied to a highly efficient light emitting element, an optical switch, and the like.

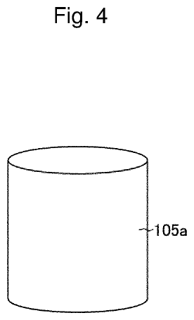

Incidentally, the microstructure 105a can be cylindrical, as shown in FIG. 4. For example, when the lattice element 103 is a cylinder, the microstructure 105a can be a cylinder. For example, the microstructure 105a can have the same height as the lattice element 103. Furthermore, the outer diameter of the microstructure 105a can be set to a value slightly smaller than the inner diameter of the lattice element 103. Furthermore, when the lattice elements 103 are a prism or a triangular prism, the microstructure 105a can be adapted to these and can be a prism or a triangular prism.

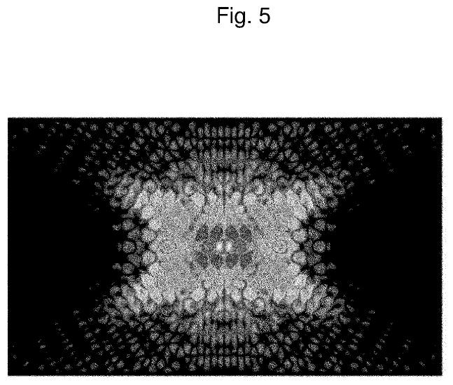

The result of simulating the magnetic field distribution of the optical element according to an embodiment in which the cylindrical microstructure 105a composed of InP (refractive index 3.3) is used and the base 102 is Si (refractive index 3.45) will be described below with reference to FIG. 5. The microstructure 105 can be prepared by patterning an InP substrate using known lithography techniques and etching techniques.

Furthermore, the lattice element 103 has a hole diameter of 230 nm and the height of the lattice element 103 (the plate thickness of the base 102) is 240 nm. Furthermore, a lattice constant of the photonic crystal body 101 (distance between adjacent lattice elements 103) is set to 430 nm. Furthermore, as an ideal condition, the simulation is performed on the assumption that the diameter of the cylindrical microstructure 105a and the hole diameter of the lattice element 103 are the same.

It can be seen that the resonator mode is formed at the position of the light confinement part 104 in which the microstructure 105a is inserted into the lattice element 103, similar to the simulation result described with reference to FIG. 2. Furthermore, a group III-V semiconductor used as a material of the microstructure 105a can have a composition in which light is emitted in the communication wavelength band and this optical element can be applied as a laser element.

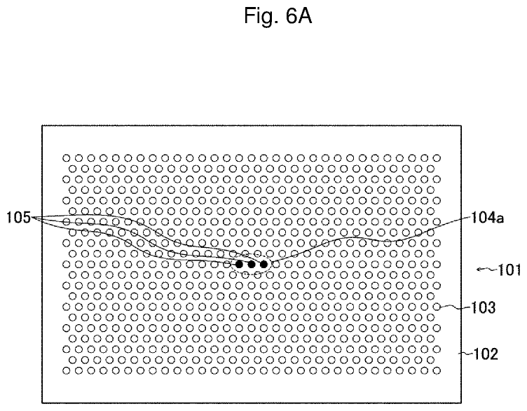

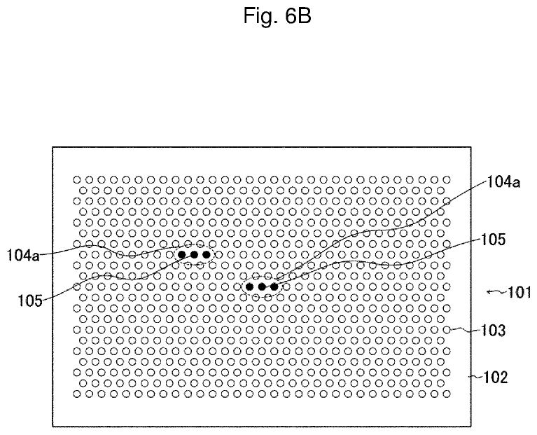

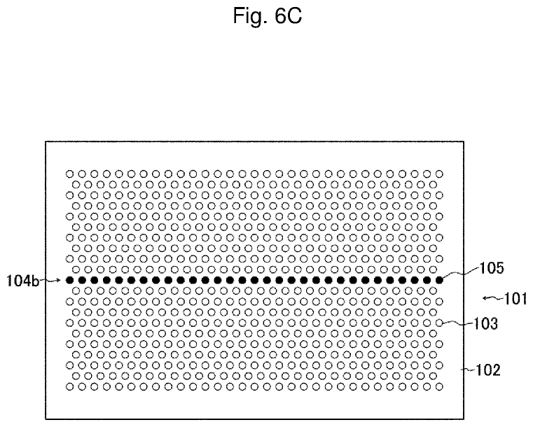

Incidentally, when the resonator is configured of the light confinement part, for example, the microstructure 105 can be inserted into three consecutive lattice elements 103 so that the microstructure 105 and the three consecutive lattice elements 103 form an L3 resonator 104a, as shown in FIG. 6A. A resonator due to three consecutive point defects of a photonic crystal is called an L3 resonator as is well known. Furthermore, when the two L3 resonators 104a are disposed close to a predetermined distance, a joined state can be generated between the two L3 resonators 104a, as shown in FIG. 6B.

In addition, an optical waveguide can be configured of a light confinement part. For example, the optical waveguide 104b can be obtained by inserting the microstructure 105 into the plurality of lattice elements 103 which are continuous on a straight line, as shown in FIG. 6C. The plurality of lattice elements 103 which are continuous on a straight line in which the microstructure 105 is inserted are a part corresponding to a core of an optical waveguide.

As described above, according to the present invention, since the microstructure made of a solid material is inserted into the lattice element, various optical elements that operate stably can be obtained by forming a photonic crystal and then forming a light confinement structure due to lattice defects.

Note that it is clear that the present invention is not limited to the embodiments described above, and many modifications and combinations can be carried out by a person having ordinary knowledge in the art within the technical idea of the present invention.
[Reference] S. Sergent et al., “Subliming GaN into Ordered Nano-wire Arrays for Ultraviolet and Visible Nanophotonics”, American Chemical Society Photonics, vol. 6, pp. 3321 to 3330, 2019.

### REFERENCE SIGNS LIST

101 Photonic crystal body
102 Base
103 Lattice element
104 Light confinement part
105 Microstructure

1. An optical element comprising:
a base and a plurality of lattice elements of a cylindrical hollow structure formed in the base, wherein
the plurality of lattice elements include a plate-like photonic crystal body periodically provided in a lattice shape at intervals equal to or less than a wavelength of target light, and
a light confinement part composed of lattice elements into which a microstructure made of a solid material is inserted.

2. The optical element according to claim 1, further comprising:
a spacer layer made of a solid material disposed between the microstructure and a side wall of the lattice element.

3. The optical element according to claim 2, wherein
the spacer layer is formed on a surface of the microstructure.

4. The optical element according to claim 2, wherein
the spacer layer is formed on a side wall of the lattice element.

5. The optical element according to claim 1, wherein
the microstructure is spherical or cylindrical.

6. The optical element according to claim 1, comprising:
a resonator composed of a light confinement part.

7. The optical element according to claim 1, comprising:
an optical waveguide composed of a light confinement part.

8. The optical element according to claim 2, wherein
the microstructure is spherical or cylindrical.

9. The optical element according to claim 3, wherein
the microstructure is spherical or cylindrical.

10. The optical element according to claim 4, wherein
the microstructure is spherical or cylindrical.

11. The optical element according to claim 2, comprising:
a resonator composed of a light confinement part.

12. The optical element according to claim 3, comprising:
a resonator composed of a light confinement part.

13. The optical element according to claim 4, comprising:
a resonator composed of a light confinement part.

14. The optical element according to claim 5, comprising:
a resonator composed of a light confinement part.

15. The optical element according to claim 2, comprising:
an optical waveguide composed of a light confinement part.

16. The optical element according to claim 3, comprising:
an optical waveguide composed of a light confinement part.

17. The optical element according to claim 4, comprising:
an optical waveguide composed of a light confinement part.

18. The optical element according to claim 5, comprising:
an optical waveguide composed of a light confinement part.

19. The optical element according to claim 6, comprising:
an optical waveguide composed of a light confinement part.
